(19) United States
(12) Patent Application Publication
(10) Pub. No.: US 2026/0208664 A1
(43) Pub. Date: Jul. 23, 2026

(54) LIGHT PROJECTING DEVICE

(71) Applicant: TOYOTA JIDOSHA KABUSHIKI KAISHA, Aichi (JP)

(72) Inventor: Satoshi TAKEGUCHI, Tokai-shi (JP)

(21) Appl. No.: 19/446,935

(22) Filed: Jan. 13, 2026

(30) Foreign Application Priority Data
Jan. 20, 2025 (JP) 2025-007890

(51) Int. Cl. B60Q 1/24; G01K 7/22; H04N 23/21; H04N 23/56; H05B 45/18

(52) U.S. Cl. CPC B60Q 1/249; H04N 23/21; H04N 23/56; H05B 45/18; G01K 7/22

(57) ABSTRACT

A light projecting device configured to be mounted on a vehicle and used in combination with a camera having sensitivity to a predetermined wavelength range, the light projecting device includes: a light projector having a light-emitting diode; a controller configured to control lighting of the light projector; and a measuring device connected to the light projector and configured to measure a junction temperature that is a sum of a heating temperature of the light projector and an ambient temperature of an area around the vehicle, wherein the controller is configured to: execute a control to heat the light projector when the junction temperature measured by the measuring device falls below a temperature range preset in accordance with the sensitivity of the camera, and execute the control to dissipate heat from the light projector when the junction temperature measured by the measuring device exceeds the temperature range.

### CROSS-REFERENCE TO RELATED APPLICATIONS

This application claims the benefit of priority from Japanese Patent Application No. 2025-007890, filed on Jan. 20, 2025, the entire contents of which are incorporated herein by reference.

### TECHNICAL FIELD

The present disclosure relates to a light projecting device.

### BACKGROUND

Japanese Unexamined Patent Application Publication No. 2007-324493 discloses a lighting device using light emitting diodes (LEDs). The lighting device includes an LED group in which LEDs are connected in series, a constant current drive circuit, a power supply circuit, and a temperature compensation circuit. The constant current drive circuit is connected to a cathode side of the LED group, and the power supply circuit is connected to an anode side of the LED group. The LED group is driven by an output voltage supplied by the power supply circuit. The temperature compensation circuit detects an ambient temperature of the LED group and generates a temperature signal. The power supply circuit adjusts the output voltage based on the temperature signal. The power supply circuit performs control to lower the output voltage when the ambient temperature becomes high and to raise the output voltage when the ambient temperature becomes low. This allows the LEDs to be driven stably regardless of temperature changes.

### SUMMARY

The lighting device described in Japanese Unexamined Patent Application Publication No. 2007-324493 may be used in combination with a camera. For example, at night, the lighting device irradiates an object with light (for example, infrared light), and a reflection from the object is imaged by the camera. Such a camera may have a filter that passes a wavelength range corresponding to the light of the lighting device and blocks light in other wavelength ranges in order to obtain a clear image.

Incidentally, a light emitting diode has a characteristic that a peak wavelength of emitted light shifts to a longer wavelength side at high temperatures, and a peak wavelength of the emitted light shifts to a shorter wavelength side at low temperatures. For this reason, if a peak shift occurs in the emitted light of the light emitting diode due to a temperature change, a spectrum of the emitted light may deviate from a passband wavelength range of a filter, and it may not be possible to obtain a light amount necessary for imaging by a camera.

The present disclosure provides a technology for suppressing a decrease in a light amount obtained by a camera due to a peak shift of emitted light of a light emitting diode accompanying a temperature change, in a light projecting device used in combination with the camera.

A light projecting device according to one aspect of the present disclosure is a light projecting device that is mounted on a vehicle and used in combination with a camera having sensitivity to a predetermined wavelength range, the light projecting device includes: a light projector that has a light emitting diode and irradiates the surroundings of the vehicle with light; a control unit that controls lighting of the light projector; and a measuring device that is connected to the light projector and measures a junction temperature, which is a sum of a heating temperature of the light projector and an environmental temperature around the vehicle, wherein the control unit executes control to heat the light projector when the junction temperature measured by the measuring device falls below a temperature range preset corresponding to the sensitivity of the camera, and executes control to dissipate heat from the light projector when the junction temperature measured by the measuring device exceeds the temperature range.

According to the present disclosure, in a light projecting device used in combination with a camera, it is possible to suppress a decrease in a light amount obtained by the camera due to a peak shift of emitted light of a light emitting diode accompanying a temperature change.

### BRIEF DESCRIPTION OF THE DRAWINGS

FIG. 1 is a block diagram showing an example of a configuration of a vehicle provided with a light projecting device according to one embodiment.

FIG. 2 is a graph showing a relationship between irradiation intensity and wavelength of a light emitting diode for each junction temperature, and also showing sensitivity of a camera.

FIG. 3 is a flowchart showing an operation of the light projecting device.

FIG. 4A is a graph showing a relationship between irradiation intensity and wavelength at a junction temperature TA, and sensitivity of a camera.

FIG. 4B is a graph showing a relationship between irradiation intensity and wavelength at a junction temperature TB, and sensitivity of a camera.

FIG. 4C is a graph showing a relationship between irradiation intensity and wavelength at a junction temperature TE, and sensitivity of a camera.

FIG. 4D is a graph showing a relationship between irradiation intensity and wavelength at a junction temperature TD, and sensitivity of a camera.

### DETAILED DESCRIPTION

Hereinafter, embodiments of the present disclosure will be described with reference to the drawings.

### Configuration of Vehicle

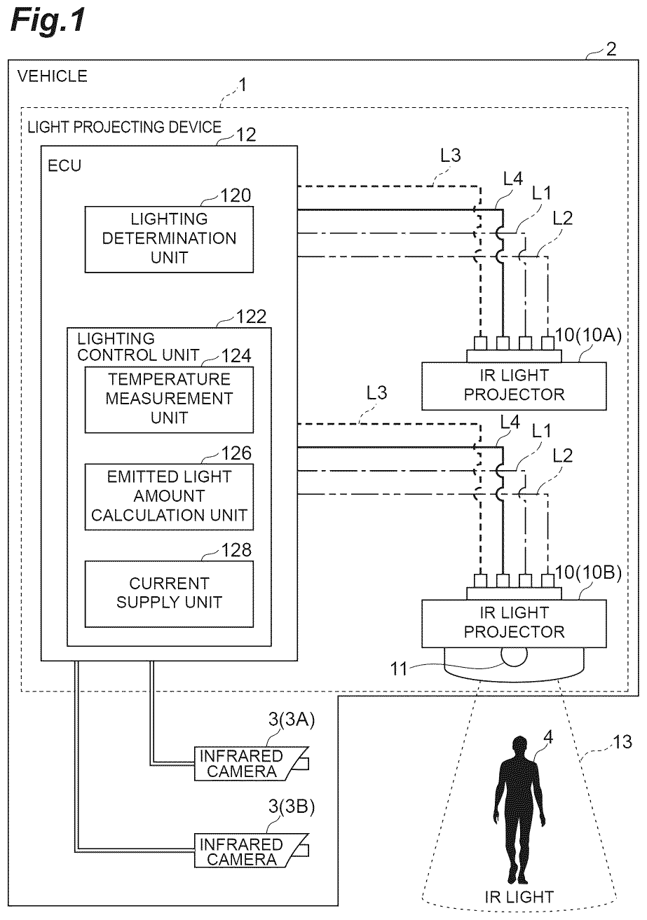

FIG. 1 is a block diagram showing an example of a configuration of a vehicle provided with a light projecting device according to one embodiment. As shown in FIG. 1, a light projecting device 1 is mounted on a vehicle 2 as an example. The vehicle 2 includes, for example, a plurality of infrared cameras 3 that capture images of surroundings of the vehicle 2. The vehicle 2 may include only one infrared camera, or may include three or more infrared cameras. Since infrared cameras 3A and 3B that constitute the plurality of infrared cameras 3 have the same configuration, the infrared camera 3A will be described below as a representative example.

The light projecting device 1 is used in combination with the infrared camera 3A. For example, the light projecting device 1 irradiates the surroundings of the vehicle 2 at night, and the infrared camera 3A acquires a video (image) of a surrounding area of the vehicle 2. In the example shown in FIG. 1, infrared light 13 is irradiated from the light projecting device 1, and a video of a pedestrian 4 is acquired by the infrared camera 3A.

The infrared camera 3A receives light in at least an infrared light region (780 nm or more) and converts it into an image. The infrared camera 3A has a band-pass filter inside the camera. The band-pass filter passes only light of a specific wavelength (for example, an infrared light region) and blocks light of other wavelengths (for example, a visible light region). The infrared camera 3A converts the light that has passed through the band-pass filter into a video. For this reason, a receivable wavelength range of the infrared camera 3A, that is, sensitivity, becomes a wavelength range that the band-pass filter passes. The infrared camera 3A may have a double band-pass filter (DBPF). The double band-pass filter passes light in two wavelength ranges, such as a visible light region (380 to 780 nm) and a part of a wavelength range of an infrared light region (for example, 800 nm to 1000 nm). The double band-pass filter provides a camera that can be used in both daytime and nighttime environments.

The light projecting device 1 includes a plurality of IR (Infrared) light projectors 10. Since an IR light projector 10A and an IR light projector 10B that constitute the plurality of IR light projectors 10 have the same configuration, the IR light projector 10B will be described below as a representative example of a light projector. Note that the light projecting device 1 may include only one IR light projector.

The IR light projector 10B has a light emitting diode 11 and irradiates the surroundings of the vehicle 2 with light. The light emitting diode 11 has an irradiation characteristic in which a relationship between irradiation intensity and wavelength varies depending on temperature. For example, a peak wavelength shifts to a longer wavelength side at a high temperature and to a shorter wavelength side at a low temperature.

The light projecting device 1 includes an ECU (Electronic Control Unit) 12 that controls lighting of the IR light projector 10B. The ECU 12 is an electronic control unit having a processor such as a CPU (Central Processing Unit), a storage device such as a ROM (Read Only Memory) and a RAM (Random Access Memory), a CAN (Controller Area Network) communication circuit, and an input/output circuit. The ECU 12 is connected to the IR light projector 10B via a power supply line L3 and a ground line L4. The ECU 12 may be configured with a plurality of ECUs.

The ECU 12 includes a lighting determination unit 120 and a lighting control unit 122 (an example of a control unit). The lighting determination unit 120 determines whether lighting of the IR light projector 10B is necessary based on an instruction from a driver or an environment around the vehicle 2. The lighting control unit 122 includes a temperature measurement unit 124, an emitted light amount calculation unit 126, and a current supply unit 128.

The temperature measurement unit 124 is connected to thermistors L1 and L2 (an example of a measuring device) that measure a junction temperature of the IR light projector 10B. The thermistors L1 and L2 are provided in the IR light projector 10B and output a signal to the temperature measurement unit 124. The junction temperature is a temperature that is a sum of a heating temperature (self-heating temperature) of the IR light projector 10B and an environmental temperature around the vehicle 2.

The emitted light amount calculation unit 126 measures an emitted light amount based on the junction temperature of the IR light projector 10B, the irradiation characteristic of the light emitting diode 11, and a camera sensitivity. The emitted light amount can be defined by an overlapping area between a spectrum showing a relationship between irradiation intensity and wavelength, and a wavelength region showing the camera sensitivity.

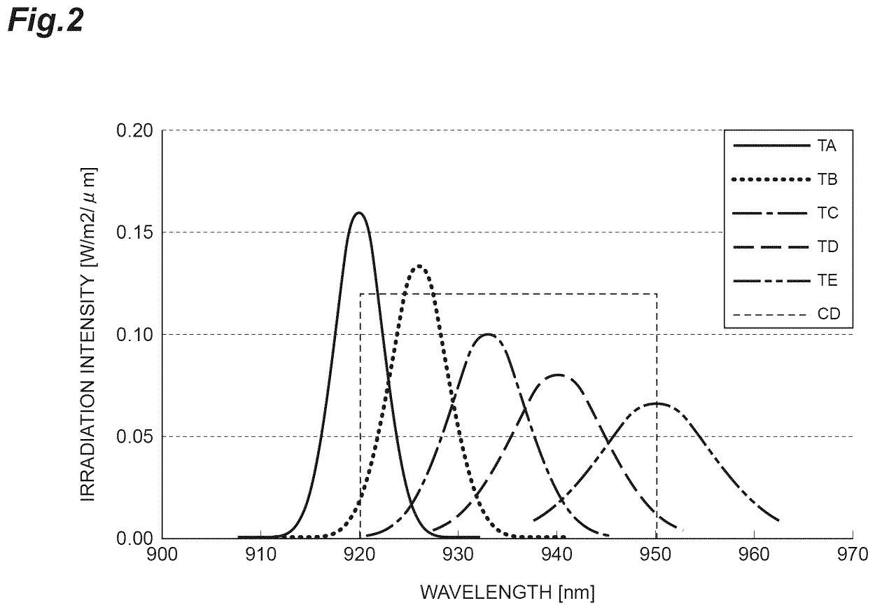

FIG. 2 is a graph showing a relationship between irradiation intensity and wavelength of a light emitting diode for each junction temperature, and also showing sensitivity of a camera. A vertical axis represents irradiation intensity, and a horizontal axis represents wavelength. FIG. 2 shows, as spectrums (graphs), a relationship between irradiation intensity and wavelength at a first junction temperature TA, a relationship between irradiation intensity and wavelength at a second junction temperature TB, a relationship between irradiation intensity and wavelength at a third junction temperature TC, a relationship between irradiation intensity and wavelength at a fourth junction temperature TD, and a relationship between irradiation intensity and wavelength at a fifth junction temperature TE. The temperatures increase in the order of the first junction temperature TA, the second junction temperature TB, the third junction temperature TC, the fourth junction temperature TD, and the fifth junction temperature TE.

As shown in FIG. 2, it can be seen that the higher the junction temperature, the more the peak wavelength shifts to the longer wavelength side, and the lower the junction temperature, the more the peak wavelength shifts to the shorter wavelength side. FIG. 2 shows a wavelength region CD indicating camera sensitivity. The camera can receive light of wavelengths within the wavelength region CD, and cannot receive light of wavelengths outside the wavelength region CD. The wavelength region CD has no temperature dependence. For this reason, an overlapping area between the wavelength region CD and the spectrum, that is, an emitted light amount, changes according to a change in the junction temperature.

Returning to FIG. 1, the ECU 12 stores in advance the irradiation characteristic of the light emitting diode 11 and the wavelength region CD. The emitted light amount calculation unit 126 calculates an emitted light amount based on the junction temperature of the IR light projector 10B measured by the temperature measurement unit 124, the prestored irradiation characteristic of the light emitting diode 11, and the wavelength region CD.

The current supply unit 128 determines whether or not the emitted light amount calculated by the emitted light amount calculation unit 126 can secure a necessary emitted light amount. The necessary emitted light amount is, for example, that 80% of a spectrum area of infrared light exists within the wavelength region CD. Since a position of a wavelength peak depends on the junction temperature, when the junction temperature is determined, it is determined whether or not the emitted light amount can secure the necessary emitted light amount.

The current supply unit 128 determines, for example, that the necessary amount of irradiation light cannot be secured when the junction temperature measured by the thermistors L1 and L2 falls below a reference temperature range preset corresponding to the sensitivity (wavelength region CD) of the infrared camera 3A. This reference temperature range can be preset, for example, based on the irradiation intensity for each wavelength of the emitted light of the IR light projector 10B shown in FIG. 2 and the sensitivity of the infrared camera 3A. In the example of FIG. 2, the reference temperature range is a range from a second junction temperature TB to a fourth junction temperature TD. Further, the current supply unit 128 determines, for example, that the necessary irradiation light amount cannot be secured when the junction temperature measured by the thermistors L1 and L2 exceeds the reference temperature range preset corresponding to the sensitivity (wavelength region CD) of the infrared camera 3A.

The current supply unit 128 executes control to heat or dissipate heat from the IR light projector 10B when it is determined that the emitted light amount calculated by the emitted light amount calculation unit 126 cannot secure the necessary emitted light amount. The current supply unit 128 executes control to heat the IR light projector 10B when the junction temperature measured by the thermistors L1 and L2 falls below the reference temperature range preset corresponding to the sensitivity of the infrared camera 3A. The current supply unit 128 executes control to dissipate heat from the IR light projector 10B when the junction temperature measured by the thermistors L1 and L2 exceeds the reference temperature range preset corresponding to the sensitivity of the infrared camera 3A.

The current supply unit 128 controls an amount of current supplied to the IR light projector 10B. The IR light projector 10B irradiates light with an intensity corresponding to the supplied amount of current. For this reason, the control to heat the IR light projector 10B is control to increase the amount of current supplied to the IR light projector 10B more than a preset amount of current. The preset amount of current is prestored in the ECU 12 as a reference amount of current. The control to dissipate heat from the IR light projector 10B is control to decrease the amount of current supplied to the IR light projector 10B less than the preset amount of current. A means for heating and heat dissipation may be anything as long as it can change the junction temperature, and is not limited to an output current.

### Operation of Light Projecting Device

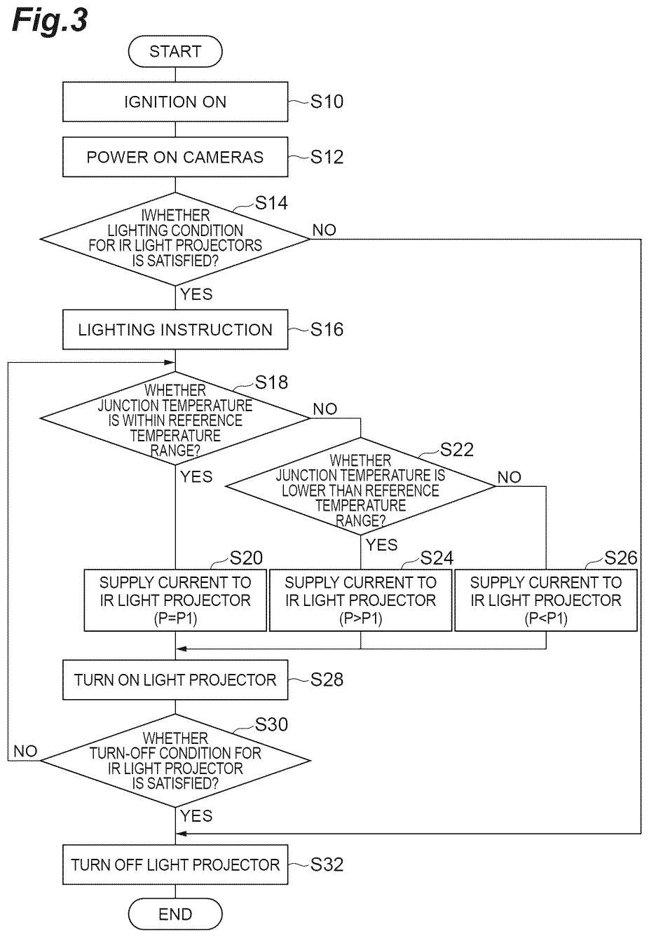

FIG. 3 is a flowchart showing an operation of the light projecting device. The flowchart shown in FIG. 3 is executed by the ECU 12 of the vehicle 2, for example, at a timing when an operation by a driver (for example, a door opening/closing operation) is received.

As shown in FIG. 3, the ECU 12 turns ON a power supply of the vehicle 2 in step S10. Subsequently, the ECU 12 powers ON the plurality of infrared cameras 3 in step S12. Then, the lighting determination unit 120 of the ECU 12 determines in step S14 whether or not a lighting condition for the plurality of IR light projectors 10 is satisfied.

When it is determined that the lighting condition is satisfied (step S14: YES), the lighting determination unit 120 outputs a lighting instruction to the lighting control unit 122 of the ECU 12 in step S16.

The lighting control unit 122 measures junction temperatures of the plurality of IR light projectors 10 in step S18. Hereinafter, the IR light projector 10B will be described as an example. The lighting control unit 122 determines whether or not the measured junction temperature is within a reference temperature range. The reference temperature range is, for example, a range from a second junction temperature TB to a fourth junction temperature TD.

When it is determined that the measured junction temperature is within the reference temperature range (step S18: YES), the lighting control unit 122 supplies a current to the IR light projector 10B with the supplied current amount P set to the first current amount P1 in step S20.

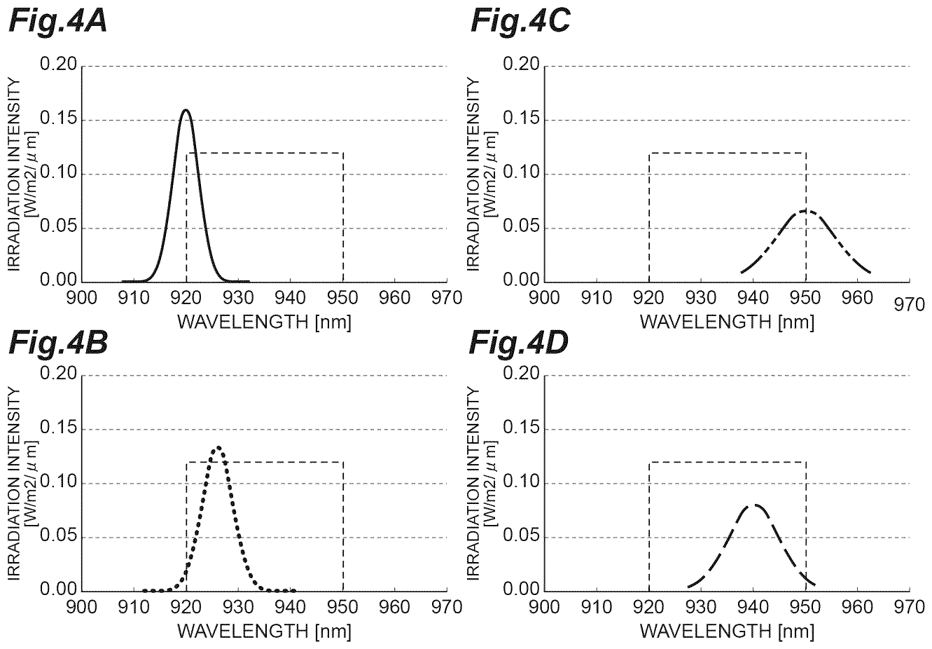

When it is determined that the measured junction temperature is not within the reference temperature range (step S18: NO), the lighting control unit 122 determines in step S22 whether or not the measured junction temperature is lower than the reference temperature range. For example, the reference temperature range is a range from the second junction temperature TB to the fourth junction temperature TD, which is a temperature range in which 80% of the spectrum area of the infrared light exists within the wavelength region CD. In the case of a first junction temperature TA, which is lower than the second junction temperature TB, which is a lower limit value, a lower limit value of the second junction temperature TB, as shown in FIG. 4A, since the peak wavelength has shifted to the shorter wavelength side, a spectrum of the irradiation intensity has a smaller area overlapping with the sensitivity of the infrared camera 3A indicated by a broken line, and there is a possibility that a light amount necessary for imaging cannot be obtained.

When it is determined that the measured junction temperature is lower than the reference temperature range (step S22: YES), the lighting control unit 122 supplies a current to the IR light projector 10B with the supplied current amount P as a second current amount P2, which is larger than the first current amount P1, in step S24. By setting the current amount to the second current amount P2, a self-heating temperature rises more than in the case of the first current amount P1, so the junction temperature rises. This makes it possible to cause the junction temperature to reach the second junction temperature TB. In the case of the second junction temperature TB, as shown in FIG. 4B, since 80% of the spectrum area of the infrared light exists within the wavelength region CD, a light amount necessary for imaging can be obtained.

When it is determined that the measured junction temperature is not lower than the reference temperature range (step S22: NO), the lighting control unit 122 determines that the measured junction temperature is higher than the reference temperature range. In the case of a fifth junction temperature TE, which is higher than an upper-limit value of the fourth junction temperature TD, as shown in FIG. 4C, since the peak wavelength has shifted to the longer wavelength side, a spectrum of the irradiation intensity has a smaller area overlapping with the sensitivity of the infrared camera 3A indicated by a broken line, and there is a possibility that a light amount necessary for imaging cannot be obtained.

For this reason, the lighting control unit 122 supplies a current to the IR light projector 10B, setting the supplied current amount P to a third current amount P3, which is smaller than the first current amount P1, in step S26. By setting the current amount to the third current amount P3, a self-heating temperature decreases more than in the case of the first current amount P1, so the junction temperature decreases. This makes it possible to cause the junction temperature to reach the fourth junction temperature TD. In the case of the fourth junction temperature TD, as shown in FIG. 4D, since 80% of the spectrum area of the infrared light exists within the wavelength region CD, a light amount necessary for imaging can be obtained.

The lighting control unit 122 supplies power to the IR light projector 10B with the amount of current determined in step S20, step S24, or step S26, whereby the IR light projector 10B is turned on in step S28. Subsequently, the lighting control unit 122 determines in step S30 whether or not a turn-off condition for the IR light projector 10B is satisfied.

When it is determined that the turn-off condition is not satisfied (step S30: NO), the lighting control unit 122 returns to step S18 and repeatedly executes the processing from step S18 to step S30. When it is determined that the turn-off condition is satisfied (step S30: YES), the lighting control unit 122 turns off the IR light projector 10B as step S32. When step S32 ends, the flowchart shown in FIG. 3 ends. Note that the processing from step S14 to step S32 in the flowchart is performed for each IR light projector.

### Summary of Embodiment

In the light projecting device 1, when the junction temperature measured by the thermistors L1 and L2 falls below a temperature range (second junction temperature TB to fourth junction temperature TD) preset corresponding to the sensitivity of the infrared camera 3A, control to heat the IR light projector 10B is executed. When the light emitting diode 11 of the IR light projector 10B is at a low temperature, there is a possibility that a peak wavelength of the emitted light shifts to a shorter wavelength side and a spectrum of the emitted light deviates from a passband wavelength range of a filter of the infrared camera 3A. Since the control to heat the IR light projector 10B is executed, a shift of the peak wavelength to the shorter wavelength side is restricted, so that deviation of the spectrum of the emitted light from the passband wavelength range of the filter of the infrared camera 3A is avoided.

Further, when the junction temperature measured by the thermistors L1 and L2 exceeds the temperature range preset corresponding to the sensitivity of the infrared camera 3A, control to dissipate heat from the IR light projector 10B is executed. When the light emitting diode 11 of the IR light projector 10B is at a high temperature, there is a possibility that a peak wavelength of the emitted light shifts to a longer wavelength side and a spectrum of the emitted light deviates from a passband wavelength range of a filter of the infrared camera 3A. Since the control to dissipate heat from the IR light projector 10B is executed, a shift of the peak wavelength to the longer wavelength side is restricted, so that deviation of the spectrum of the emitted light from the passband wavelength range of the filter of the infrared camera 3A is avoided. Therefore, the light projecting device 1 can suppress a decrease in the light amount obtained by the camera due to the peak shift of the emitted light of the light emitting diode 11 accompanying a temperature change when used in combination with the infrared camera 3A. Further, by dissipating heat, overheating of the light emitting diode is avoided.

Note that, as the DBPF of the infrared camera 3A, one that passes visible light and a part of a wavelength range of infrared light is adopted, but it is also conceivable to suppress a decrease in the light amount obtained by the camera by widening the part of the wavelength range of the infrared light. However, with such a measure, there is a possibility that image quality may be adversely affected by the influence of disturbance light such as sunlight during the daytime. In addition, selecting a light emitting diode with good temperature characteristics also leads to an increase in component costs. In the light projecting device 1, since it is not necessary to change the filter of the infrared camera 3A and the light emitting diode of the IR light projector 10B, it is possible to avoid the risk of image quality deterioration and suppress a decrease in the light amount obtained by the infrared camera without increasing component costs.

Although the exemplary embodiments have been described above, various omissions, substitutions, combinations, and modifications may be made without being limited to the above-described exemplary embodiments.

What is claimed is:

1. A light projecting device configured to be mounted on a vehicle and used in combination with a camera having sensitivity to a predetermined wavelength range, the light projecting device comprising:
a light projector having a light-emitting diode and configured to illuminate an area around the vehicle with light;
a controller configured to control lighting of the light projector; and
a measuring device connected to the light projector and configured to measure a junction temperature that is a sum of a heating temperature of the light projector and an ambient temperature of an area around the vehicle,
wherein the controller is configured to:
execute a control to heat the light projector when the junction temperature measured by the measuring device falls below a temperature range preset in accordance with the sensitivity of the camera, and
execute the control to dissipate heat from the light projector when the junction temperature measured by the measuring device exceeds the temperature range.

2. The light projecting device according to claim 1, wherein
the light projector is configured to irradiate light with an intensity corresponding to an amount of current supplied thereto,
the controller is configured to the control the amount of current supplied to the light projector,
the control to heat the light projector is the control to increase the amount of current supplied to the light projector to be greater than a preset amount of current, and
the control to dissipate heat from the light projector is the control to decrease the amount of current supplied to the light projector to be less than the preset amount of current.

3. The light projecting device according to claim 2, wherein the controller is configured to set the amount of current supplied to the light projector to the preset amount of current when the junction temperature measured by the measuring device is within the temperature range.

4. The light projecting device according to claim 1, wherein the temperature range is preset based on an irradiation intensity for each wavelength of irradiated light from the light projector and the sensitivity of the camera.
